(19) United States
(12) Patent Application Publication
(10) Pub. No.: US 2026/0036798 A1
(43) Pub. Date: Feb. 5, 2026

(54) Light Sheet Microscope

(71) Applicant: Izak van Cruyningen, Tiburon, CA (US)

(72) Inventor: Izak van Cruyningen, Tiburon, CA (US)

(21) Appl. No.: 19/287,665

(22) Filed: Jul. 31, 2025

Related U.S. Application Data
(60) Provisional application No. 63/679,033, filed on Aug. 2, 2024.

(51) Int. Cl. G02B 21/00

(52) U.S. Cl. CPC G02B 21/0032; G02B 21/0052; G02B 21/008

(57) ABSTRACT

A light sheet microscope that combines the eye safety and economy of high etendue light sources like LEDs with the spatial resolution of low etendue light sources like lasers is proposed. Light emission from one or more high etendue sources is optically formed into light sheets whereby images of specimens illuminated by the light sheets provide spectral information. Light one or more low etendue light sources is formed into thinner light sheets to provide images with better spatial information. The light source wavelengths can be selected for improved eye safety. Image fusion synergistically combines the noteworthy spectral information captured from the high etendue light sheets with the exceptional spatial information captured from the low etendue sheet to create more informative images.

### CROSS-REFERENCE TO RELATED APPLICATIONS

This application claims the benefit of provisional patent application Ser. No. 63/679,033 filed 2024 Aug. 2 by the present inventor.

### BACKGROUND—PRIOR ART

Light sheet microscopes use a thin sheet of light as a virtual slide to illuminate the objects of interest. They eliminate the need to mount samples on slides, thereby allowing in situ undisturbed examination of specimens.

Light sheet microscopes also substantially reduce photobleaching and phototoxic effects on samples by only illuminating a plane in the objective's depth of field (DOF). Conventional light and fluorescence microscopes illuminate an entire cone of light, including many objects outside the DOF. The extra background light reduces contrast, adds blurry portions in the foreground and background, and overexposes the tissue of interest. Light sheet microscopes only illuminate in or around the objective DOF, minimizing light contribution from out of focus specimens and creating highly focused images with vivid contrast.

Confocal microscopes scan a bright light across the field of view with multiple focused exposures of each area, which also leads to photobleaching and phototoxic effects from excessive light exposure on specimens.

Light sheet microscopes currently use lasers, and this light source is viewed as essential: “LSFM [Light Sheet Fluorescence Microscopy . . . ] requires a laser as its light source” E. Stezler, p. 6 Foreword to text Light Sheet Fluorescence Microscopy Reynaud, E. G., & Tomancak, P. (Eds.). (2024). Lasers can produce nearly collimated beams with a small spot size, so they have low etendue. A simple cylindrical lens can form the laser beam into a thin light sheet suitable for light sheet fluorescence microscopy.

Fluorescence microscopes selectively identify stains or pigments by detecting their fluorescence. They first illuminate the sample with a bright excitation light. A fraction of the light is scattered and the rest is absorbed. Then, a fraction of the absorbed light is emitted as fluorescence at a longer Stokes-shifted wavelength to be detected separately from the scatter.

Most fluorophores and phytopigments absorb in the visible wavelengths and therefore must be excited by light in the visible wavelengths. The eye focuses visible light on the retina, so bright visible light lasers can burn the retina, causing permanent damage and possibly blindness. ANSI publishes maximum permissible exposure (MPE) for lasers depending on wavelength and pulse length. Ultraviolet light below 400 nm is absorbed in the cornea, so it does not reach the retina and has a much lower risk of irreparably injuring the retina. For example, the MPE for 315 to 400 nm laser illumination of 1 ms duration is 100,000 J/cm². For 400 to 700 nm visible light lasers, the MPE for a 1 ms pulse is 10 μJ/cm², or about 10,000 times less (ANSI Z136-1 Tables 5a and b). This means UVA laser illumination can be 10,000 times brighter than visible laser light for the same risk to the eye.

More generally, long-pass laser safety goggles that permit some viewing of visible light are available at higher optical densities for shorter wavelengths. For blue laser light OD 6, or 1,000,000 times, attenuation is readily and inexpensively available. Shorter wavelengths are inherently safer for the eyes and are more easily filtered with goggles.

Light-emitting diodes (LEDs) provide reliable illumination at a broad range of wavelengths at substantially lower cost than lasers. LEDs emit over a wide angle (typically 120° full-width half maximum (FWHM)) over a broad source (typically more than 1 mm²), so they have high etendue and are typically much safer for eyes than lasers at comparable wavelengths. Etendue cannot be decreased in an optical system that conserves optical power. Realistically, etendue always increases. Therefore, it is a formidable challenge to create a thin light sheet over an extended field of view (FOV) when starting with a high etendue source such as an LED. In a white paper by laser manufacturer Coherent, entitled “Lasers versus LEDs for Bioinstrumentation,” M. Schulze calculates only 2% of an LED's light can be focused into a spot comparable to the size of a laser spot. LEDs are usually only a tiny fraction as power and cost efficient when forming a thin light sheet as compared to lasers.

### SUMMARY

I propose a light sheet microscope that combines the eye safety and economy of high etendue light sources like LEDs with the spatial resolution of low etendue light sources like lasers. Light emission from one or more high etendue sources is optically formed into light sheets whereby images of specimens illuminated by the light sheets provide spectral information. Light one or more low etendue light sources is formed into thinner light sheets to provide images with better spatial information. The light source wavelengths can be selected for improved eye safety. Image fusion synergistically combines the noteworthy spectral information captured from the high etendue light sheets with the exceptional spatial information captured from the low etendue sheet to create more informative images.

### Advantages

This invention allows eye-safe light sheet microscopy with both good spatial and good spectral resolution, even in 400-700 nm visible wavelengths. Various aspects of the embodiments of the Light Sheet Microscope are superior because
Visible light LEDs with high etendue are much safer for eyes than similar low etendue laser light sources.
The broader emission spectrum of LEDs (10-20 nm FWHM) is a much better match with the broad absorption spectra of fluorophores and phytopigments. Narrow laser lines (1-2 nm FWHM) can saturate and photobleach the fluorophores and phytopigments, reducing the signal to noise ratio and killing or irreversibly damaging the specimen.
LEDs are much less expensive than lasers (˜1-10% of the cost).
Standard LEDs are available in more wavelengths (colors) that match absorption peaks in fluorophores or phytopigments. For example, many phytopigment absorption peaks match standard LED colors: Chlorophyll-a (440 nm Royal Blue), Chlorophyll-b (470 nm Blue), B-Phycoerythrin (492 nm Cyan), R-Phycoerythrin (549 nm Green or Lime), and Phycocyanin (621 nm Red).

Additional unanticipated advantages include:
The shorter wavelength light of low etendue light sources has better spatial resolution than visible light,
The shorter wavelength light has a longer Rayleigh or confocal range to allow a larger field of view without losing spatial resolution as the beam width exceeds the objective DOF,
LEDs are less sensitive to power fluctuations.
LEDs of certain wavelengths are more power efficient than their laser counterparts
LEDs tolerate higher temperatures, so they require less cooling
Laser light sources often produce speckle that introduces noise into measurements.

Other advantages of one or more aspects will be apparent from considering the drawings and ensuing description.

### FIGURES

The patent or application file contains at least one drawing executed in color. Copies of this patent or patent application publication with color drawing(s) will be provided by the Office upon request and payment of the necessary fee.

1. Isometric view of a Light Sheet Microscope with dichroic mirrors and a close-up of the field of view.

2. Absorption and fluorescence spectra for Chlorophyll-a detection.

3. Absorption and fluorescence spectra for Chlorophyll-b detection.

4. Absorption and fluorescence spectra for Phycoerythrin detection.

5. Absorption and fluorescence spectra for Phycocyanin detection.

6. Perspective view of a Light Sheet Microscope with multiple lenses and filters.

7. Perspective view of a single lens and Bayer image array implementation.

8. Flowchart for a Light Sheet Microscope.

### DETAILED DESCRIPTION

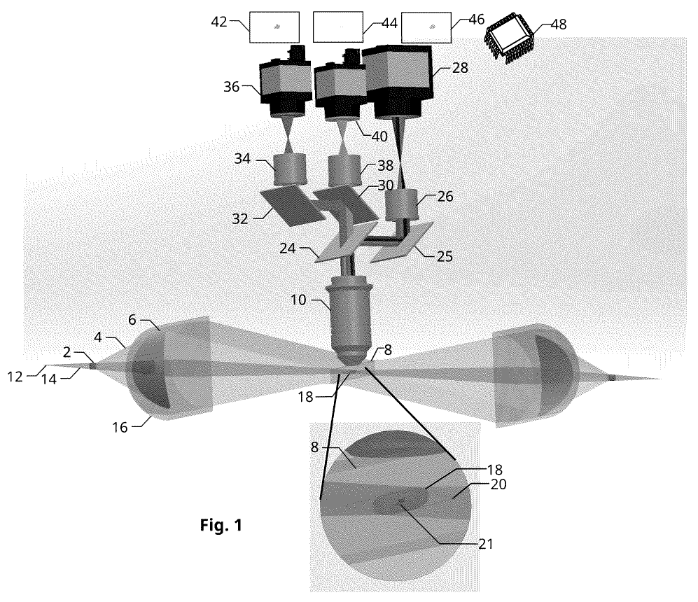

This section describes several embodiments of the Light Sheet Microscope with reference to FIGS. 1-8.

FIG. 1 is an isometric view of a Light Sheet Microscope implemented with dichroic mirrors. A high etendue light source 2, high etendue beam forming optics 6, low etendue light source 12, and low etendue beam forming optics 16 are mounted and aligned to form horizontal high etendue light source light sheet waist 8 and low etendue light source light sheet waist 18. The light sheets are substantially at right angles to objective 10, with the horizontal optical axes at or near the working distance of objective 10 to capture in-focus images.

Objective 10's vertical optical axis through its centerline is aligned with dichroic mirrors 24 and 30, tube lens 38, and second spectral image array 40. Dichroic mirror 24 directs shorter wavelengths to mirror 25 that reflects the light through tube lens 26 to spatial image array 28. Dichroic mirror 30 reflects the longer wavelengths to mirror 32 which reflects the light through tube lens 34 to first spectral image array 36.

An example high etendue light source is an LED and that term will be used to represent a high etendue light source in this specification. LED source 2, has an extent of ˜1 mm and emits LED light 4 into a ˜120° FWHM cone so it has high etendue. LED optic 6 intersects a fraction of LED light 4 and forms it into a sheet with LED waist 8 at or near the working distance of objective 10.

An example low etendue light source is a laser and that term will be used to represent a low etendue light source in this specification. Laser source 12, emits laser light 14 over an extent of ˜10 μm into a ˜15° FWHM angle so it has very low etendue. Laser optic 16 intersects more of laser light 14 and forms it into a narrow sheet with laser waist 18 at or near the working distance of objective 10. Laser optic 16 could be adjacent to, in line with, opposite, or any other orientation relative to LED optic 6. The LED and laser could also share the same optic 6, as shown here. Laser light sheet waist 18 is typically a fraction of the thickness of LED light sheet waist 8 because laser source 12 has a much lower etendue than LED source 2.

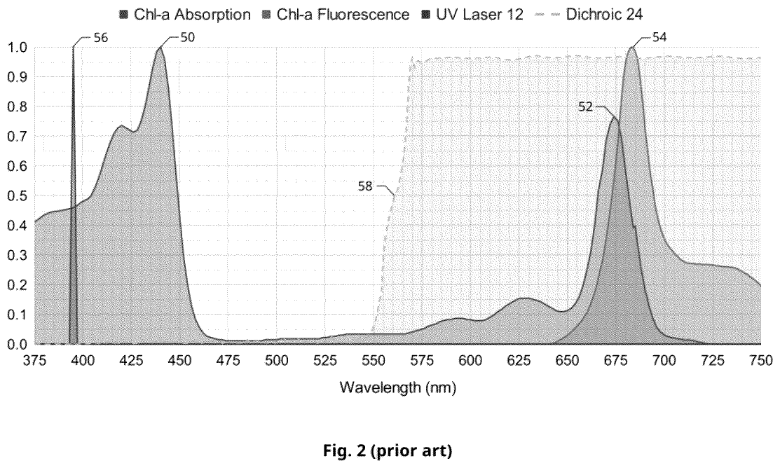

Sample 21 scatters some of laser light 14 at the laser wavelength. It absorbs some and emits a fraction of the absorbed light as fluorescence at a longer Stokes-shifted wavelength. FIG. 2, discussed below, illustrates these wavelengths for Chlorophyll-a. Objective 10 captures both the scatter and the emitted fluorescence within field of view 20 and directs them to dichroic mirror 24. Dichroic mirror 24 transmits light longer than the cut-on wavelength toward dichroic 30 and reflects light at shorter wavelengths toward mirror 25. In this example, mirror 25 reflects through tube lens 26 to high spatial resolution image array 28 which captures high spatial resolution image 46.

Dichroic mirror 24 transmits longer wavelengths to dichroic mirror 30. Dichroic mirror 30 reflects wavelengths longer than the cut-off wavelength to mirror 32, which directs them through tube lens 34 onto the first spectral image array 36 to capture the first spectral image 42. Dichroic mirror 30 transmits wavelengths shorter than the cut-off wavelength through tube lens 38 to second spectral image array 40 which captures second spectral image 44.

Image fusion means, running on processor and memory 48, synergistically fuses high spatial resolution image 46 with high spectral resolution images 42 and 44 to produce images with exceptional spatial and spectral resolution. Processor and memory 48 could be part of the microscope, on another computer or microcontroller interacting with the microscope, or even in the cloud.

Different color LEDs will stimulate different phytopigments or fluorophores, as illustrated in FIGS. 2, 3, 4, and 5. For example, many LED emission spectra closely match phytopigment absorption peaks such as Chlorophyll-a (440 nm Royal Blue), Chlorophyll-b (470 nm Blue), B-Phycoerythrin (492 nm Cyan), R-Phycoerythrin (549 nm Green or Lime), Phycocyanin (621 nm Red), etc.

Adding a high color rendering index white LED would allow for images of natural colors. Adding a short wavelength UV-C LED (e.g., 265 nm) would help prevent biofouling by sterilizing the illuminated area.

FIG. 1 illustrates symmetric illumination from two sides to reduce shadowing effects. Extending this illumination to three, four, or more sides reduces shadows even more. Illumination could also be from just one side for easier access to larger samples.

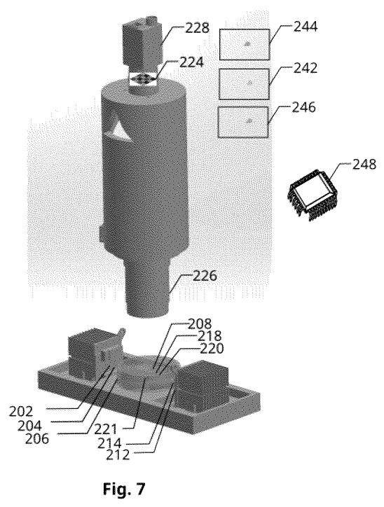

FIG. 1 illustrates one spatial image array 28 and two spectral image arrays 36 and 40. The principle could be applied to one spatial and one spectral image array, but could readily be extended to any number of spatial or spectral image arrays. FIG. 7 illustrates a special case where the spatial and spectral images are captured by the same image array.

FIG. 2 is an illustration of absorption and fluorescence spectra for Chlorophyll-a detection. The vertical axis is the relative response normalized to one, and the horizontal axis is the wavelength in nanometers. Humans perceive visible light ranging from 400 to 700 nanometers. Chlorophyll-a primarily absorbs blue and red wavelengths with a first Chlorophyll-a absorption peak 50 (440 nm) and a second Chlorophyll-a absorption peak 52 (675 nm). Some fraction of the absorbed light is emitted as fluorescence with a Chlorophyll-a fluorescence peak 54 (685 nm). This fraction is known as the quantum yield and is approximately 0.2 to 2% for Chlorophyll-a.

In this example, the laser source 12 emits a narrow ultraviolet (UV) laser light spectrum 56 at less than 400 nm. The absorption at this shorter wavelength is less than the absorption at the first Chlorophyll-a absorption peak 50, so Chlorophyll-a only absorbs about half as much light as it would at the first Chlorophyll-a absorption peak 50. However, the eye safety maximum permissible exposure MPE in the ultraviolet below 400 nm at UV laser light spectrum 56 is 10,000 times higher than in the visible wavelength at first Chlorophyll-a absorption peak 50, so a 10,000 times as bright light can be used to create a 5,000 times higher signal to noise ratio at the same level of eye-safety.

Dichroic mirror 24 reflects wavelengths below the cut-on wavelength 58 to mirror 25. Mirror 25 reflects the light through tube lens 26 onto spatial image array 28. Dichroic mirror 24 transmits Chlorophyll-a fluorescence with peak 54 to dichroic mirror 30 that reflects it to mirror 32, then through tube lens 34 to the first spectral image array 36 to isolate the dimmer fluorescence with a high signal-to-noise ratio. Separating excitation and emission wavelengths improves the SNR for fluorescence.

Chlorophyll-a is a good indicator of health in photosynthetic organisms such as plants, algae, and bacteria. Pixels capturing fluorescence indicate the presence of a living photosynthetic organism, whereas those without fluorescence likely observe inorganic materials like soil, sand, water, marine snow, or other dead organics.

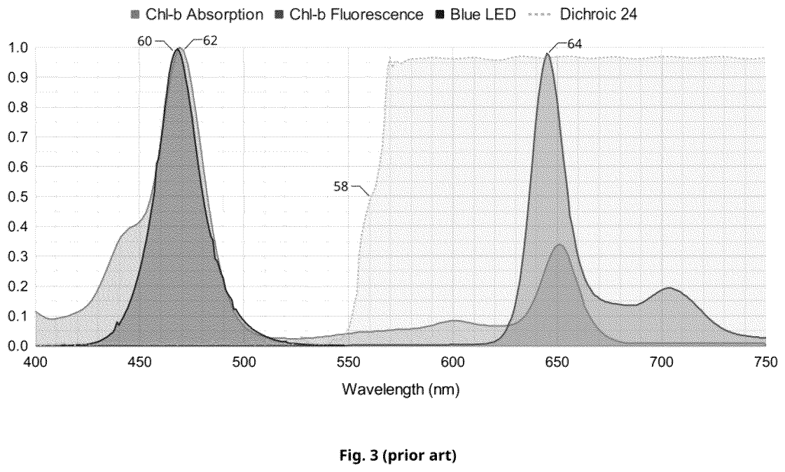

FIG. 3 is an illustration of absorption and fluorescence spectra for Chlorophyll-b detection. Chlorophyll-b absorbs primarily blue with a Chlorophyll-b absorption peak 62 (470 nm). Blue LED illumination with peak 60 is an excellent match with both the peak location and width of the Chlorophyll-b absorption. Some fraction of the absorbed light is emitted as fluorescence with a Chlorophyll-b fluorescence peak 64 (646 nm). Dichroic mirror 24 with cut-off wavelength 58 separates scattered blue LED light captured on spatial image array 28 from the Chlorophyll-b fluorescence 64 captured on first spectral image array 36. Fluorescence of Chlorophyll-b indicates green algae or plants.

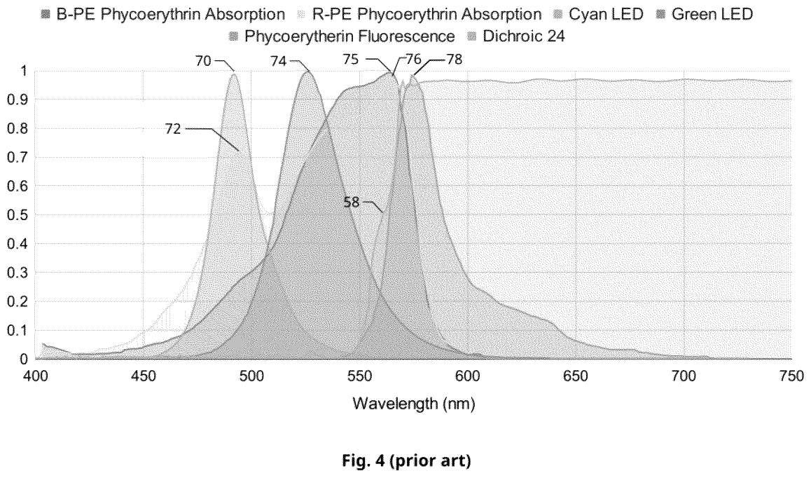

FIG. 4 illustrates the absorption and fluorescence spectra for Phycoerythrin (R-PE and B-PE) detection and distinguishes R-PE in red algae from B-PE in both cyanobacteria and red algae. B-PE absorbs with a broad B-PE peak 75 (545 to 565 nm). R-PE has a narrower R-PE absorption peak 76 (565 nm) but also a smaller secondary R-PE absorption peak 72 (495 nm), which matches well with a cyan LED emission peak 70. A green LED with peak emission 74 (525 nm) matches a large part of the B-PE absorption spectrum with only a tiny overlap above cut-on wavelength 58 of dichroic filter 24. Both B-PE and R-PE fluoresce with a Phycoerythrin fluorescence peak 78 (575 nm). The cyan and green LEDs flash sequentially. In both cases, the LED scatter wavelengths are directed by dichroic filter 24 to spatial image array 28 and the fluorescence wavelengths to first spectral image array 36 for acquisition in sequential images and use in later image fusion.

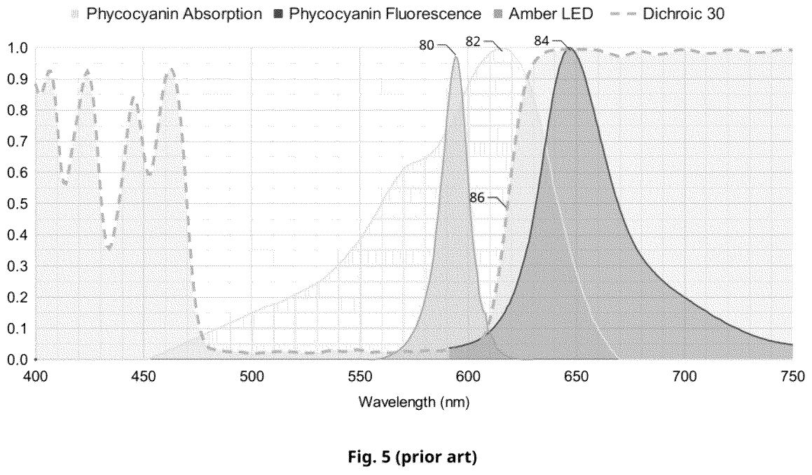

FIG. 5 illustrates the absorption and fluorescence spectra for Phycocyanin detection characteristic of cyanobacteria. Phycocyanin absorbs over a broad range with a Phycocyanin absorption peak 82 (615 nm). It fluoresces with a Phycocyanin fluorescence peak 84 (650 nm). Illumination with amber LED emission peak 80 (595 nm) is well absorbed, but has little overlap with cut-on wavelength 86 (618 nm) of dichroic mirror 30. Dichroic mirror 30 with cut-on wavelength 86 (618 nm) will separate the scatter of amber illumination from the red fluorescence, allowing separate capture on image arrays 40 and 36 respectively. The Phycocyanin fluorescence with peak 84 is directed to the second spectral image array 40 to locate cyanobacteria. The ringing in dichroic mirror 30 below 450 nm is insignificant because dichroic mirror 24 reflects these wavelengths toward spatial image array 28 earlier in the optical train, meaning signal in the ringing region never reaches dichroic 30.

When absorption or emission spectra overlap, they are distinguished by sequential flashes. For example, in FIG. 4, Phycoerythrin R-PE and B-PE have the same fluorescence emission spectrum but different absorption spectra, allowing them to be separated with sequential flashes of cyan and green LEDs.

When both spectra for two pigments are distinct and the dichroic mirrors adequately separate them, the apparatus can acquire both images simultaneously. For Chlorophyll-a in FIG. 2 and Phycoerythrin in FIG. 4, neither absorption nor emission curves overlap significantly. With a simultaneous flash of violet and cyan LEDs, spatial image array 28 will capture illumination scattering, first spectral image array 36 will capture Phycoerythrin fluorescence, and second spectral image array 40 will capture Chlorophyll-a fluorescence.

Sequencing the light flashes in order of the quantum yield reduces the impact of photobleaching, meaning more of the sample is actively absorbing and fluorescing for each sequential flash and a higher fluorescence signal will be read as compared to a different order that results in more photobleaching.

FIGS. 2-5 illustrate spectral absorption and fluorescence and the method for detecting particular photosynthetic pigments to image algae, bacteria, or plants. This approach can be extended to, for example, fluorophores used in sample staining, plastics with different spectral responses, or other materials with varying reflectivity or fluorescence responses.

The above examples used fluorescence as an illustration, but other variations in the interaction of light with a sample are possible such as Raman scattering or changes of refractive index with illumination.

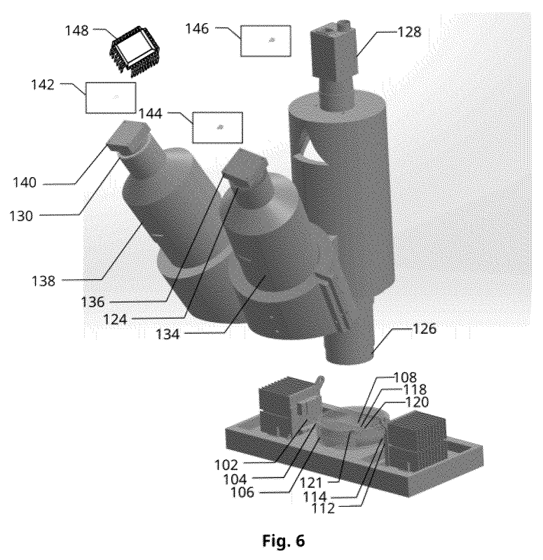

FIG. 6 is a perspective view of an alternative implementation of the Light Sheet Microscope using multiple lenses, filters, and image arrays. LED light source 102 emits LED light 104 in a broad fan that is aligned on a horizontal optical axis through the sides of lens 106. Lens 106 intercepts part of LED light 104 and redirects it into a horizontal LED light sheet with waist 108 at or near the working distance of lens 126. Laser light source 112 emits a narrower fan of laser light 114. Laser light source 112 is also horizontally aligned with lens 106, so lens 106 shapes laser light 114 into a horizontal laser light sheet with waist 118 at or near the working distance of lens 126.

Lens 126 images field of view 120 that includes sample 121 onto spatial image array 128 which captures high resolution laser image 146. Both laser light sheet waist 118 and LED light sheet waist 108 illuminate field of view 120.

Lens 134 and first spectral image array 136 are aligned on an optical axis that overlaps field of view 120 to capture first spectral image 144 through longpass filter 124. For the example of Chlorophyll-b detection (FIG. 3), LED source 102 is a blue light with peak illumination 60 (470 nm). Part of this light is scattered by sample 121. Another part is absorbed and emitted as fluorescence at the longer Chlorophyll-b fluorescence peak 64 (646 nm). Light captured by lens 134 is filtered by longpass filter 124 that transmits the longer wavelength fluorescent light, e.g. Chlorophyll-b fluorescence peak 64 (646 nm), and blocks the shorter wavelength LED light 60 (470 nm), removing the scattered light and capturing an image of the fluorescence alone.

Lens 138 images field of view 120 through longpass filter 130 onto second spectral image array 140. Lens 138 and second spectral image array 140 are aligned on an optical axis that overlaps field of view 120 to capture second spectral image 142. For the example of Phycocyanin detection (FIG. 5), the LED light source is an amber LED with emission peak 80 (595 nm). Sample 121 will scatter some of the amber LED illumination. It will also absorb some light and fluoresce at the longer wavelength Phycocyanin fluorescence peak 84 (650 nm). Longpass filter 130 transmits the fluorescence and blocks the scatter, allowing for a higher signal to noise ratio of the fluorescence.

An image fusion algorithm running on processor and memory 148 is used as a means for combining spatial information from image 146 with spectral information from images 142 and 144 to construct a high fidelity image with excellent spectral and spatial resolutions.

FIG. 7 is a perspective view of a third alternative implementation of the Light Sheet Microscope that uses a single image array 228 with a Bayer filter 224. LED light source 202 emits LED light 204 in a broad fan that is aligned on a horizontal optical axis through the sides of lens 206. Lens 206 forms LED light 204 into a horizontal LED light sheet waist 208. Laser light source 212 emits a narrower fan of laser light 214. Laser light source 212 is also aligned with the horizontal axis of lens 206 such that lens 206 shapes laser light 214 into a light sheet waist 218.

Lens 226 images field of view 220 that includes sample 221 onto Bayer filter image array 228. Both laser light sheet waist 218 and LED light sheet waist 208 illuminate field of view 220.

To detect Chlorophyll-a, FIG. 2, laser light source 212 is flashed while the shutter in Bayer filter image array 228 is open. Some laser illumination near laser wavelength peak 56 will scatter off sample 221. The blue pixels in Bayer filter image array 228 will record this scatter in blue image 246. Sample 221 will absorb some of the remaining light and emit a portion as fluorescence with a longer wavelength at Chlorophyll-a fluorescence peak 54 (685 nm). The red pixels in Bayer filter image array 228 will record mostly the fluorescence in red image 244. Bayer filter 224 allows simultaneous capture of scatter for spatial resolution and fluorescence for spectral resolution.

To detect Chlorophyll-b (FIG. 3) in the same manner, a blue LED flash with emission peak 60 would be used. To detect Phycoerythrin R-PE (FIG. 4), a cyan LED flash with emission peak 70 would be used. In this case, scatter would be recorded with the green Bayer pixels, and fluorescence would be detected with the red Bayer pixels.

Image fusion means running on processor and memory 248 combines spatial information from image 246 with spectral information from images 242 and 244 to construct a high fidelity image with the best of the spectral and spatial resolutions from the inputs.

FIGS. 1, 6, and 7 have illustrated three possible implementations using different
Light sources: high etendue light sources like LEDs in multiple colors and low etendue light sources like lasers
Optics to form light sheets: spherical, cylindrical, or toroidal lenses
Lenses: camera lenses, macro lenses, or microscope objectives with tube lenses
Filters: dichroic, longpass, shortpass, and Bayer
Image arrays: spatial, spectral, and Bayer
   Persons skilled in the art can readily make modifications and changes that are still within the scope. For example, incandescent, arc, and mercury vapor lamps are high etendue sources like LEDs. They can be matched as described here with low etendue light sources such as lasers, laser pumped phosphors, or other laser driven light sources.

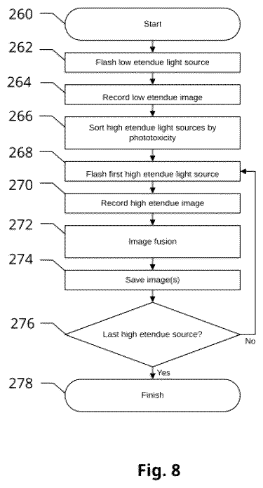

FIG. 8 illustrates a sample flow chart for the Light Sheet Microscope. To start 260 acquisition of a high resolution multispectral image, flash the low etendue light source 262 and record the low etendue image 264, as illustrated in FIG. 1 by 46.

Sort the high etendue light source colors and brightness in order of phototoxicity 266 to the sample 21, 121, or 221. If there is only one high etendue light source, this is unnecessary. If the low etendue light source is more phototoxic than any high etendue light source, then flash it after the high etendue light sources.

If the speed of image acquisition is slow relative to the motion of sample 21, then it becomes harder to correlate sample location in the different images. Changes to the pulse train including but not limited to additional low etendue light source flashes may be necessary.

Flash a high etendue light source 268 and record the high etendue image 270 as illustrated in FIG. 1 by 42. Then use image fusion means 272 to fuse the high spatial resolution low etendue light source image with the high spectral resolution high etendue light source image to produce an image with high spatial and spectral resolution.

The ideas behind panchromatic sharpening come from passive remote sensing with satellites. Satellites such as WorldView 3 have a panchromatic image array that captures a broad range of wavelengths, e.g., a range of 350 nm from a short wavelength of 450 to a long wavelength of 800 nm. The satellites also have multiple narrow-band multispectral image arrays, e.g., ˜40 nm each.

These satellites rely on passive illumination, i.e. sunlight reflected by the earth. The proposed Light Sheet Microscope has active illumination with carefully chosen wavelengths and illumination profiles.

The reflected sunlight contains fewer photons in the narrow multispectral bands, so the multispectral image array pixels must be larger than the panchromatic image array pixels for the same signal-to-noise ratio. Typical of many satellites, the World View 3 multispectral image array pixels are four times larger in each dimension than panchromatic pixels, so they have one-quarter the panchromatic resolution. Panchromatic sharpening algorithms combine the panchromatic band's high spatial resolution with the multispectral image arrays' high spectral resolution to produce high spatial and spectral resolution images.

Sample panchromatic sharpening algorithms include, for example,
component substitution approaches in the spatial domain such as Intensity-Hue-Saturation, Brovey, Principal Component Analysis, or Gram-Schmidt that have good spatial fidelity but often some spectral distortion,
multi-resolution or frequency domain analysis such as Wavelet transform, Laplacian pyramids, contourlet, or Generalized Laplacian pyramids (GLP) that produce better spectral results with some spatial distortions or
machine learning or deep learning approaches trained on millions of sample images.

Mathematically, panchromatic sharpening relies on the
spatial alignment of the images. Spatial misalignment causes color fringing or ringing. In the Light Sheet Microscope we align the fields of view of the multiple image arrays, first mechanically and then fine tuned in image processing.
spectral overlap of the multispectral bands with the panchromatic band. If the spectral overlap is small or absent, as may occur with WorldView 3 for coastal or near-infrared 2 bands, the potential distortions become more severe.

Image fusion is a broader concept than panchromatic sharpening. It has been defined as gathering all the important information from multiple images to produce fewer, more informative images. Examples include
Combine under and overexposed images to produce a high dynamic range image.
Combine a near-focus image with a far-focus image to produce an image with a large depth of field.
Combine visible and infrared images to produce contrast and rich textures, even in low-light conditions.
Combine structural (magnetic resonance imaging, computed tomography, or phase contrast) and functional (Positron Emission Tomography, Single Photon Emission Computed Tomography, or green fluorescent protein) medical images to produce a single image with richer information.
Combine high spatial resolution images with high spectral resolution images as discussed under panchromatic sharpening above.

One implementation of the proposed Light Sheet Microscope combines
the high-spatial-resolution images 46, 146, 246 from the scatter of the thinner laser light waist 18, 118, or 218 from sample 21, 121, or 221
the high spectral resolution images 42, 142, 242 or 44, 144, 244 from illumination of sample 21, 121, or 221 by LEDs and recording of the fluorescence of LED light.
   with image fusion algorithms as a means to synergistically create images with high spatial and spectral resolution.

Save the images 274 in FIG. 8. If there are more high etendue light sources 276, then flash 268 and process them. When all are processed and saved, then the multispectral image acquisition is complete 278.

This section illustrated details of specific embodiments, but persons skilled in the art can readily make modifications and changes that are still within the scope. For example, the discussion has focused on phytopigments but extends to fluorophores, plastics, microparticles of any kind, or other materials.

I claim:

1. An apparatus comprising
an image array and a lens;
a high etendue light source;
optics to shape illumination from said high etendue light source into a high etendue light source light sheet with a waist at or near the working distance of said lens so said image array captures a high etendue image of specimens illuminated by said high etendue light source light sheet;
a low etendue light source;
optics to shape illumination from said low etendue light source into a low etendue light source light sheet with a waist at or near the working distance of said lens so said image array captures a low etendue image of specimens illuminated by said low etendue light source light sheet;
image fusion means combining information from said high etendue image with information from said low etendue image;
whereby the fused image has improved spatial or spectral resolution.

2. The apparatus of claim 1 wherein the high etendue light source is a light emitting diode.

3. The apparatus of claim 1 wherein the high etendue light source wavelength is chosen to substantially overlap an absorption spectrum in a specimen.

4. The apparatus of claim 1 further comprising a plurality of high etendue light sources.

5. The apparatus of claim 1 wherein the low etendue light source is a laser.

6. The apparatus of claim 1 further comprising a plurality of low etendue light sources.

7. The apparatus of claim 1 wherein the low etendue light source wavelength is safer for human eyes than the high etendue light source wavelength.

8. The apparatus of claim 1 wherein the low etendue light source wavelength is scattered by a specimen.

9. The apparatus of claim 1 wherein the high etendue light source and low etendue light source are flashed at different times.

10. The apparatus of claim 1 wherein an optical filter separates the light captured in said high etendue light source image and said low etendue light source image.

11. The apparatus of claim 1 further comprising a first lens coupled to a first image array to capture said high etendue image and a second lens coupled to a second image array to capture said low etendue image.

12. The apparatus of claim 1 wherein image fusion means uses panchromatic sharpening.

13. A method to capture high spatial and high spectral images of a specimen, the method comprising the steps of:
acquiring a high spectral resolution image of specimens in a light sheet formed from a high etendue light source;
acquiring a high spatial resolution image of specimens in a light sheet formed from a low etendue light source;
fusing said high spectral resolution image and said high spatial resolution image.

14. The method of claim 13 further comprising acquiring additional high spectral resolution images and applying said fusing to the additional high spectral resolution images.

15. The method of claim 14 further comprising acquiring additional high spatial resolution images and applying said fusing to the additional high spatial resolution images.

16. The method of claim 15 further comprising sorting the acquisition sequence in order of photobleaching of the specimen.
